(19) United States
(12) Patent Application Publication
(10) Pub. No.: US 2015/0196994 A1
(43) Pub. Date: Jul. 16, 2015

(54) Ratchet Wrench with Easy Assembly

(71) Applicant: NEW WAY TOOLS CO., LTD., Taichung City (TW)

(72) Inventor: Ping-Wen Huang, Taichung City (TW)

(73) Assignee: NEW WAY TOOLS CO., LTD., Taichung City (TW)

(21) Appl. No.: 14/182,336

(22) Filed: Feb. 18, 2014

(30) Foreign Application Priority Data
Jan. 15, 2014 (TW) 103101409

(51) Int. Cl. B25B 13/46; B25B 23/00; B25B 13/04

(52) U.S. Cl. CPC B25B 13/463; B25B 13/04; B25B 23/0007

(57) ABSTRACT

A ratchet wrench includes a head. The head delimits a receiving space and a recess. The recess connects with the receiving space. The recess delimits an opening adjacent to the receiving space. A gear wheel is disposed in the receiving space and includes an outer circumference defining a first engaging area. A pawl mechanism is restrained in the recess and includes a surface defining a second engaging area facing and in ratcheting engagement with the first engaging area. A groove is defined on the outer circumference of the gear wheel. The pawl mechanism engages with the groove and restrains the gear wheel in the receiving space.

### BACKGROUND OF THE INVENTION

1. Field of the Invention

The present invention relates to a ratchet wrench and, in particular, to a ratchet wrench that is easy to assemble.

2. Description of the Related Art

TW Patent No. M423025 shows a wrench including a body delimiting a curved recess and a hole connecting with the curved recess, a curved component, a gear wheel, and a retainer ring. In the process of assembling the wrench, the curved component is first disposed into the curved recess, then the gear wheel is disposed into the hole, and after the gear wheel is received in the hole the retainer ring is used to restrain the gear wheel in the hole.

The present invention is, therefore, intended to provide a wrench that is easier to assemble and is made at a reduced cost than the prior art.

### SUMMARY OF THE INVENTION

According to the present invention, a ratchet wrench ratchet wrench with easy assembly includes a body including a head. The head delimits a receiving space and a recess. The receiving space extends through the body. The body includes two opposite lateral walls and a support wall extending between the two lateral walls made of the same material of the body. The recess is delimited by the two lateral walls and the support wall. The recess connects with the receiving space. The recess delimits an opening adjacent to the receiving space. A gear wheel is disposed in the receiving space and includes an inner circumference defining a driving area for attaching an object to be driven by the ratchet wrench and an outer circumference defining a first engaging area. A pawl mechanism is restrained in the recess and includes a surface defining a second engaging area facing and in ratcheting engagement with the first engaging area. A groove is defined on the outer circumference of the gear wheel. The pawl mechanism engages with the groove and restrains the gear wheel in the receiving space.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an objective of the present invention to provide a ratchet wrench that is easy to assemble.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a head of a ratchet wrench in accordance with a first embodiment of the present invention.

FIG. 2 is an exploded perspective view of FIG. 1.

FIG. 3 is a cross-sectional view taken along line 3-3 of FIG. 1.

FIG. 4 is a cross-sectional view taken along line 4-4 of FIG. 1.

FIG. 5 is a cross-sectional view of the ratchet wrench of FIG. 1 and shows the operation of the ratchet wrench in a first operation direction, with the arrow indicating the first operating direction.

FIG. 6 is a cross-section view of the ratchet wrench of FIG. 1 and shows the operation of the ratchet wrench in a second operating direction.

FIG. 7 is an exploded perspective view of a head of a ratchet wrench in accordance with a second embodiment of the present invention.

FIG. 8 is a cross-sectional view of the ratchet wrench of FIG. 7.

FIG. 9 is an exploded perspective view of a head of a ratchet wrench in accordance with a third embodiment of the present invention.

FIG. 10 is an exploded perspective view of a head of a ratchet wrench in accordance with a fourth embodiment of the present invention.

FIG. 11 is a cross-sectional view of the ratchet wrench of FIG. 10.

FIG. 12 is an enlarged cross-sectional view of FIG. 11.

### DETAILED DESCRIPTION OF THE INVENTION

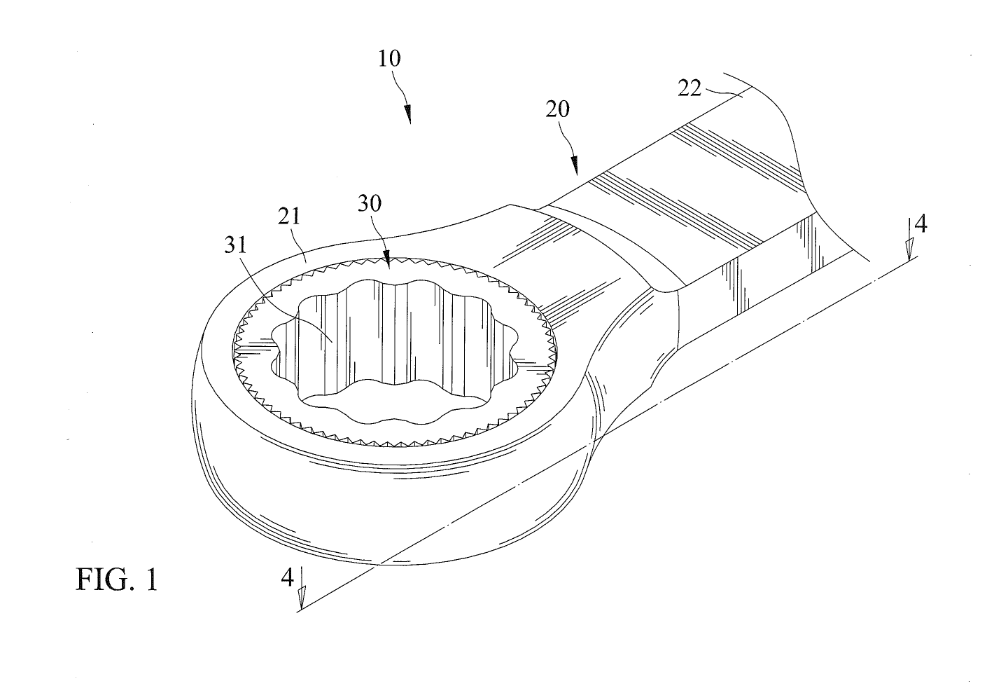

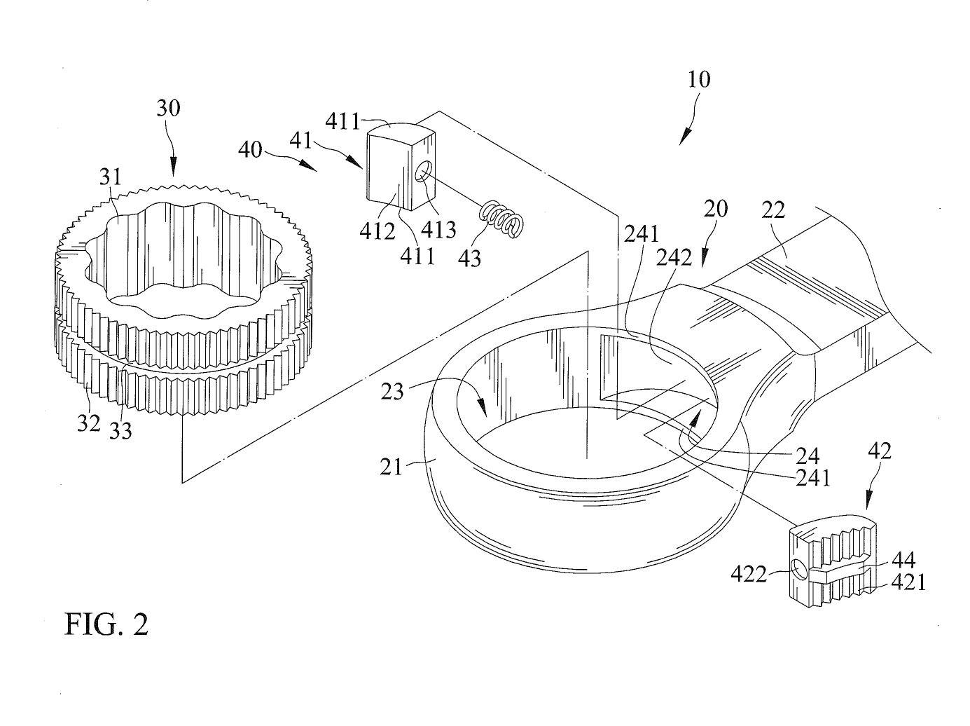

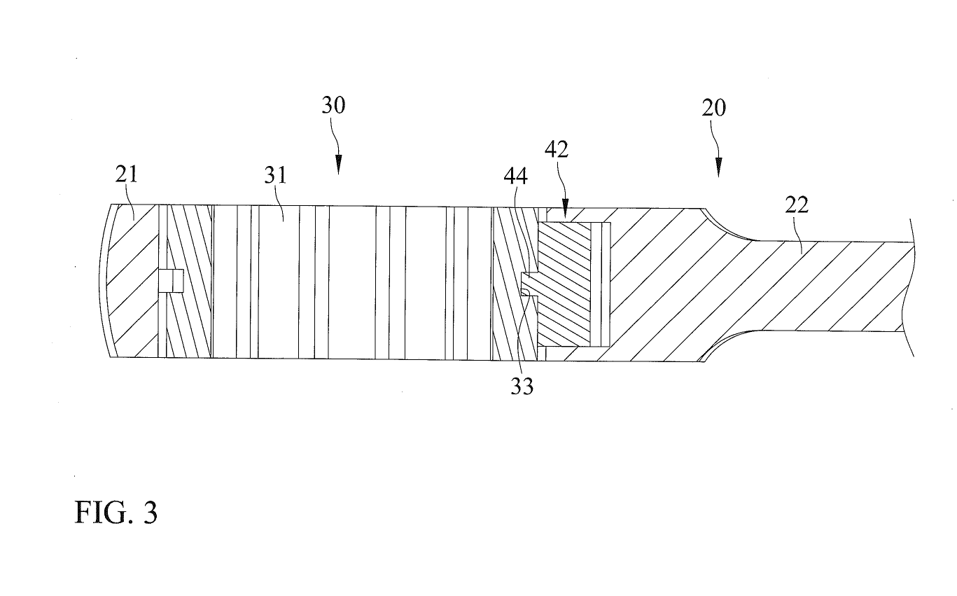

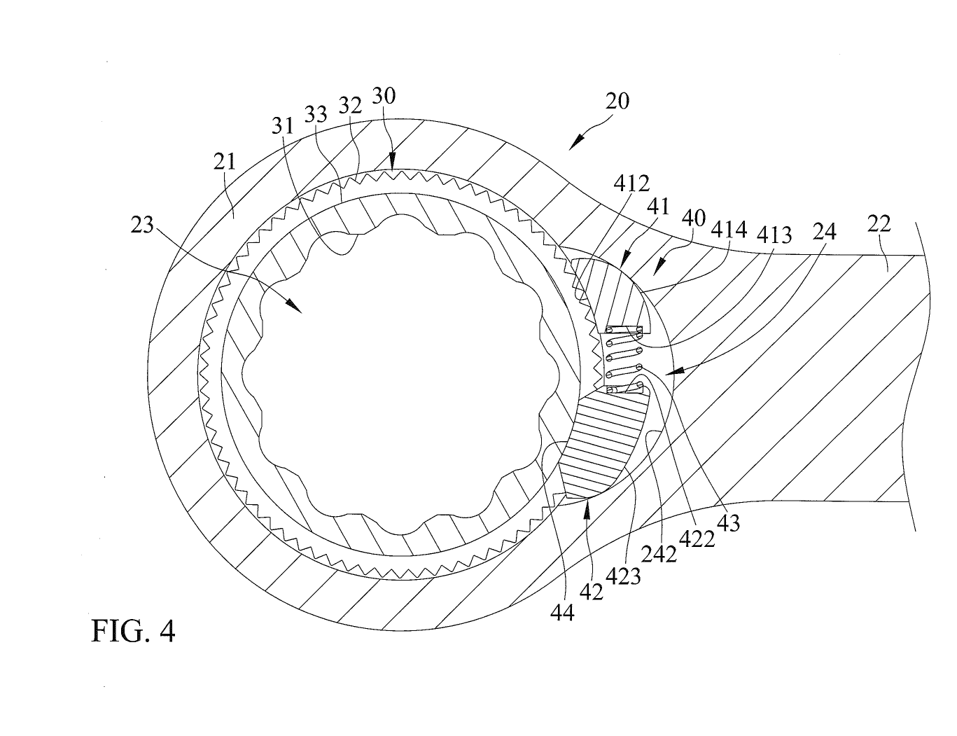

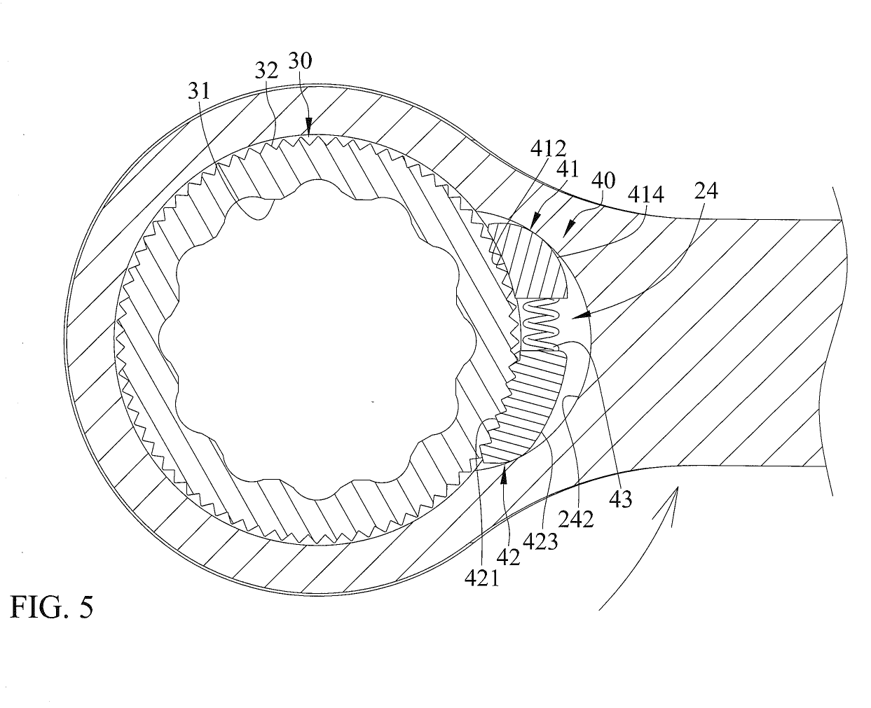

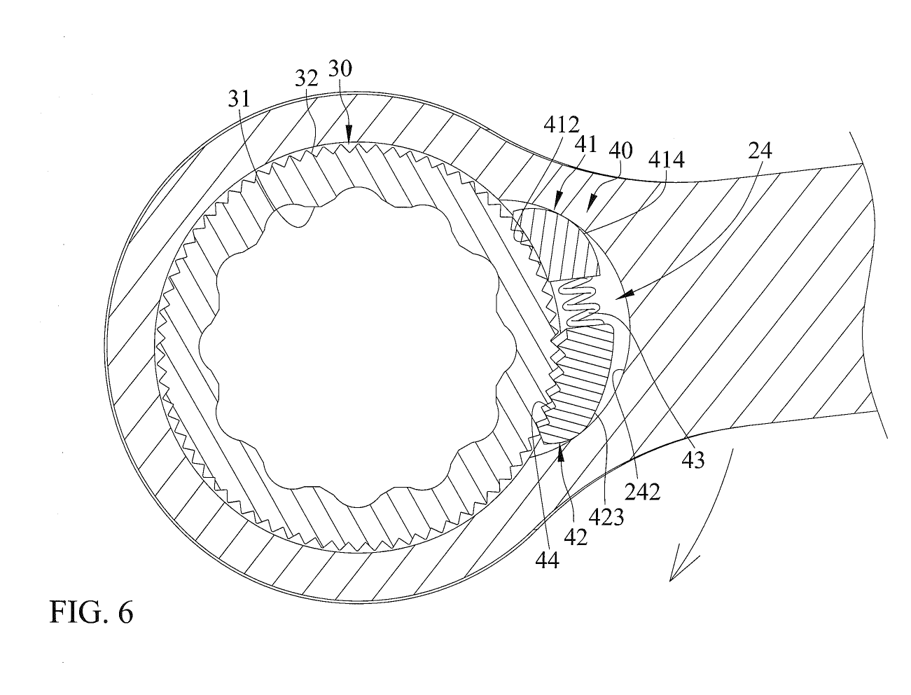

FIGS. 1 through 6 show a ratchet wrench 10 with easy assembly in accordance with a first embodiment of the present invention. The ratchet wrench 10 includes a body 20 including a head 21. The head 21 delimits a receiving space 23 and a recess 24. The receiving space 23 extends through the body 20. The body 20 includes two opposite lateral walls 241 and a support wall 242 extending between the two lateral walls 241 made of the same material of the body 20. The recess 24 is delimited by the two lateral walls 241 and the support wall 242. The recess 24 includes the two lateral walls 241 at different heights and opposite each other and the support wall 242 facing the receiving space 23. The recess 24 connects with the receiving space 23. The recess 24 delimits an opening adjacent to the receiving space 23. The opening of the recess 24 has a width determined by a distance between two ends of the support wall 242, and a height determined by a distance between the two lateral walls 241. The body 20 also includes a bar 22 extending from the outer periphery of the head 21. A user of the ratchet wrench 10 can grasp on the bar 22 for better leverage.

A gear wheel 30 is disposed in the receiving space 23 and includes two opposite distal ends uncovered. The gear wheel 30 is rotatable about an axis. The gear wheel 30 includes an inner circumference defining a driving area 31 for attaching an object to be driven by the ratchet wrench 10 and an outer circumference defining a first engaging area 32. The outer circumference of the gear wheel 30 extends annularly.

A pawl mechanism 40 is restrained in the recess 24. The pawl mechanism 40 includes a surface defining a second engaging area 421 facing and in ratcheting engagement with the first engaging area 32. The first engaging area 32 includes a plurality of first teeth disposed circumferentially on the outer circumference of the gear wheel 30. The second engaging area 421 includes a plurality of second teeth facing and in ratcheting engagement with the plurality of first teeth. The pawl mechanism 40 includes a first pawl 41, a second pawl 42 and a biasing member 43 disposed between the first and second pawls 41 and 42, with the biasing member 43 including a first end abutting against the first pawl 41 and a second end abutting against the second pawl 42. The first pawl 41 includes a peripheral edge thereof including a first concavity 413 receiving the first end of the biasing member 43. The second pawl 42 includes a peripheral edge thereof including a second concavity 422 receiving the second end of the biasing member 43. One of the first and second pawls 41 and 42 includes the second engaging area 421. In this embodiment, the second pawl 42 includes the second engaging area 421. Moreover, the pawl mechanism 40 includes the other of the first and second pawls 41 and 42 including a side 412 forming an even surface that faces the first engaging area 32 and is able to loosely abut against a top land of each of the plurality of first teeth. The side 412 has a concave periphery so that it will not impede the ability of the gear wheel 30 to rotate.

Each of the first and second pawls 41 and 42 includes a mounting side 414 and 423 supported by the support wall 242. In this embodiment, each of the support wall 242 and the mounting sides 414 and 423 of the first and second pawls 41 and 42 has a curved periphery, which can facilitate engagement/disengagement between the first and second engaging areas 32 and 421. The first pawl 41 includes two lateral edges 411 opposite each other and corresponding to the two lateral walls 241.

A groove 33 is defined on the outer circumference of the gear wheel 30. The groove 33 extends annularly on the outer circumference of the gear wheel 30 and transverses to the plurality of first teeth. The pawl mechanism 40 engages with the groove 33 and restrains the gear wheel 30 in the receiving space 23. Specifically, one of the first and second pawls 41 and 42 includes a flange 44 restrained in the groove 33. In this embodiment, the flange 44 protrudes from the second pawl 42 and from the second engaging area 421.

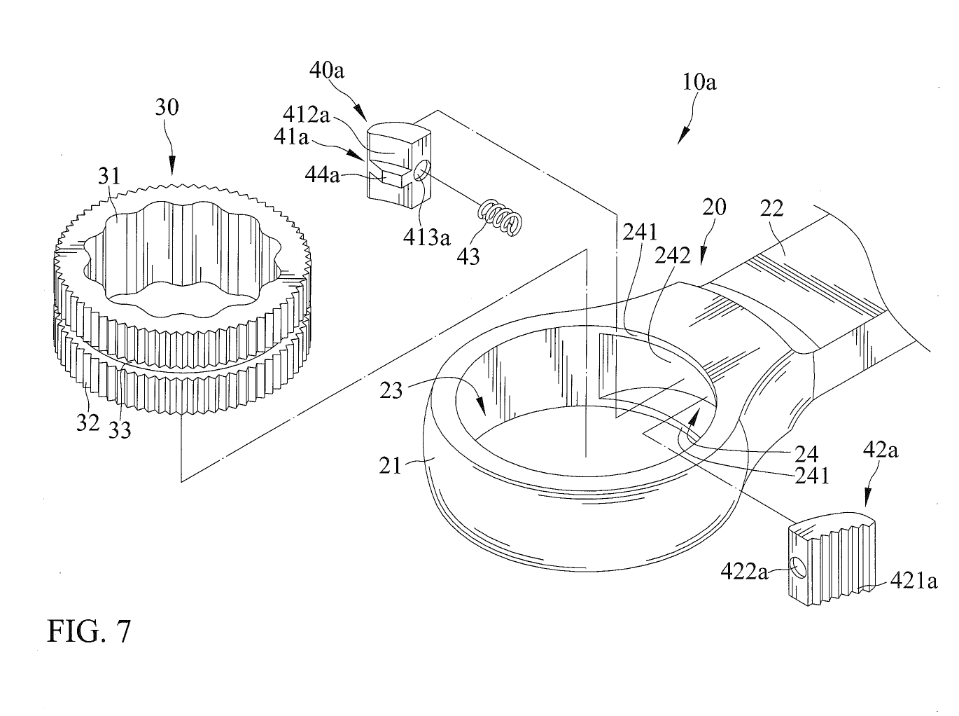

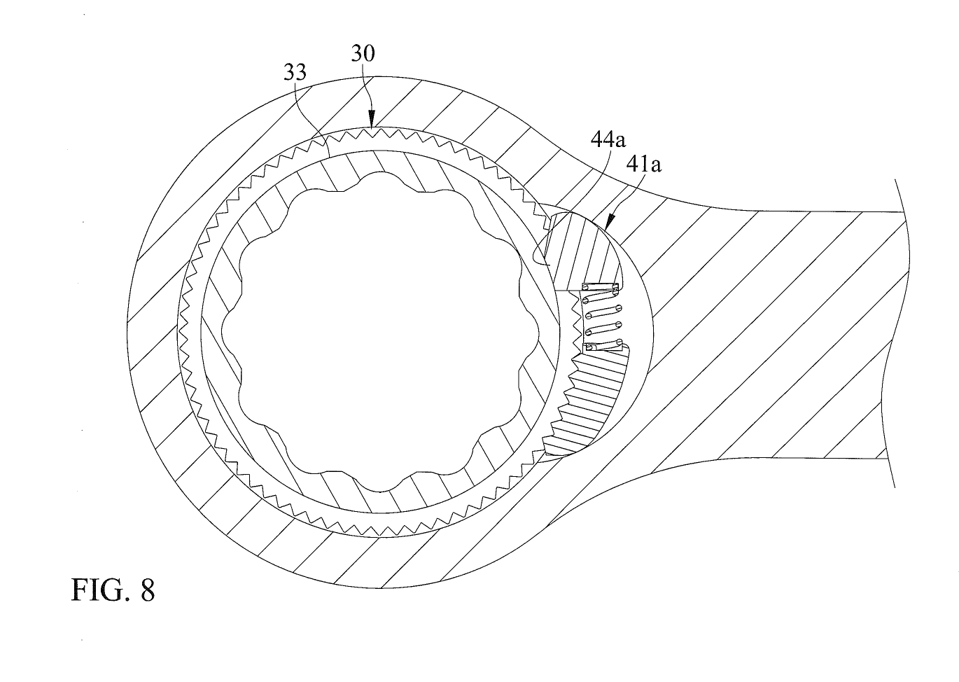

FIGS. 7 and 8 show a ratchet wrench 10a in accordance with a second embodiment of the present invention, and same numbers are used to correlate similar components of the first embodiment, but bearing a letter a. The second embodiment is similar to the first embodiment except a flange 44a protrudes from a side 412a of a first pawl 41a of a pawl mechanism 40a. Furthermore, a second pawl 42a includes a second engaging area 421a, but does not include a flange protruding from second engaging area 421a as in the first embodiment. For comparison, the first pawl 41a also includes a peripheral edge thereof including a first concavity 413a receiving the first end of the biasing member 43. Likewise, the second pawl 42a includes a peripheral edge thereof including a second concavity 422a receiving the second end of the biasing member 43.

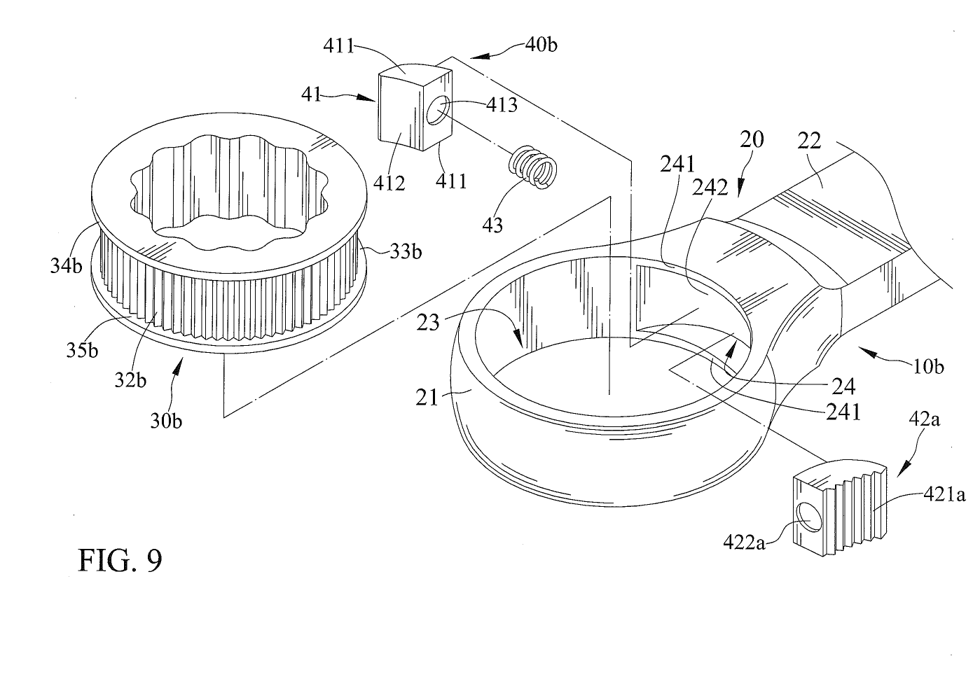

FIG. 9 shows a ratchet wrench 10b in accordance with a third embodiment of the present invention, and same numbers are used to correlate similar components of the first embodiment, but bearing a letter b. The third embodiment differentiates from the first embodiment in that a gear wheel 30b includes an outer circumference thereof including a first stop rim 34b and a second stop rim 35b opposite the first stop rim 34b, and a groove 33b is delimited between the first and second stop rims 34b and 35b. Furthermore, a pawl mechanism 40b includes the first pawl 41 and the second pawl 42a. The pawl mechanism 40b engages with the groove 33b and restrains the gear wheel 30b in the receiving space 23.

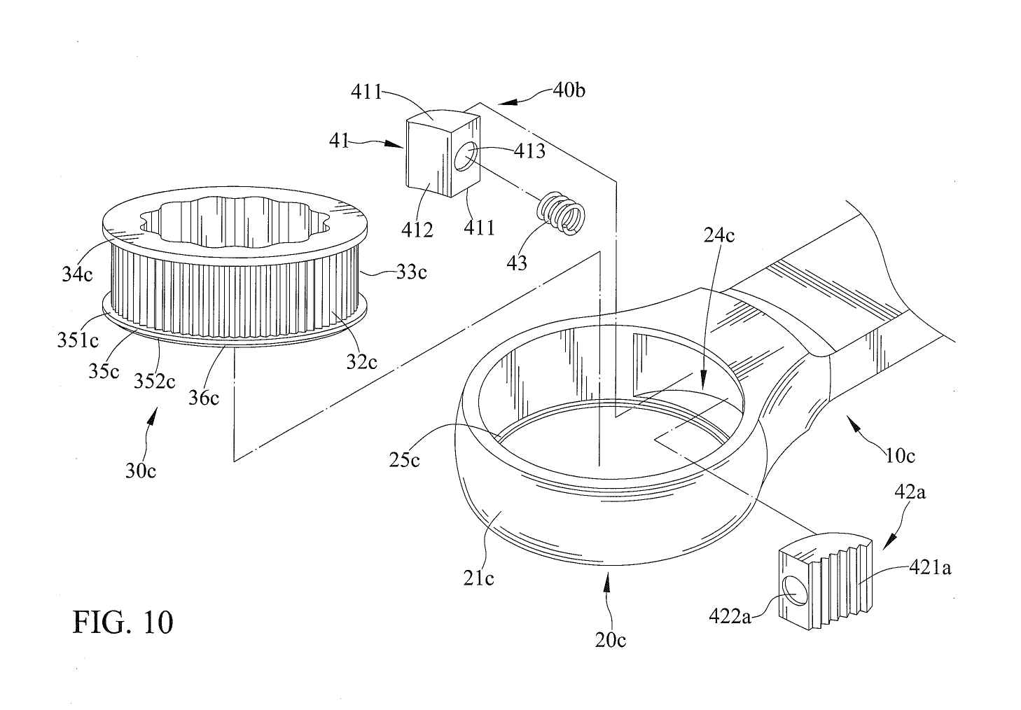

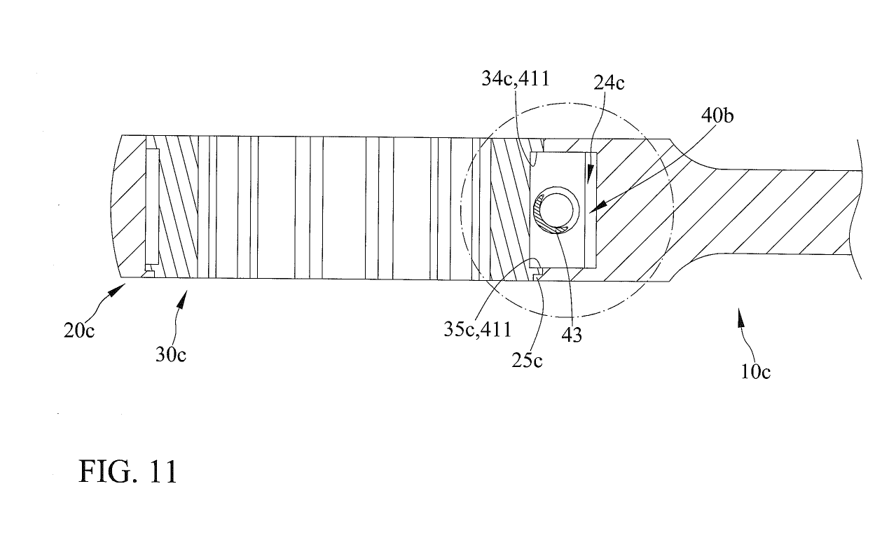

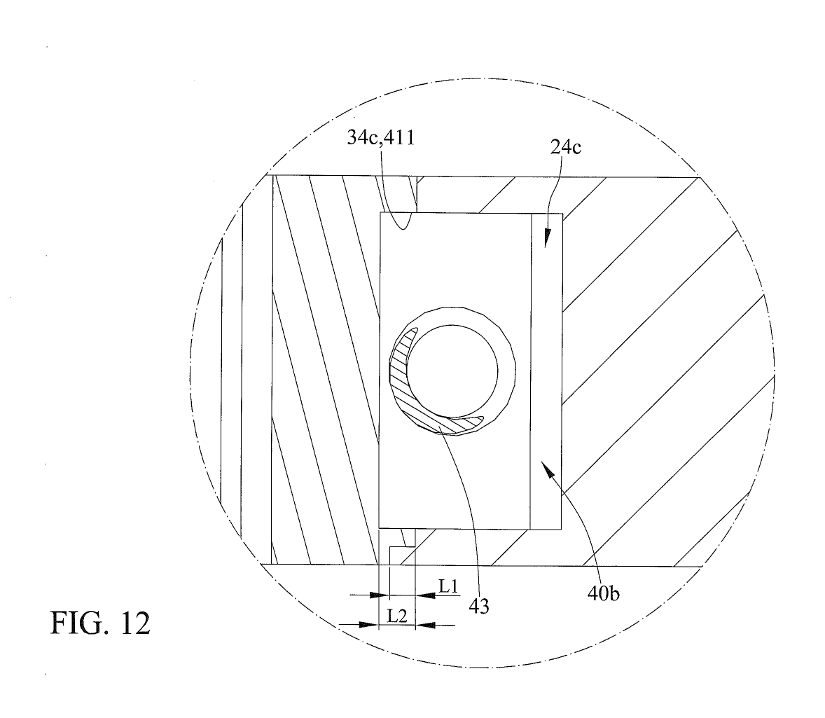

FIGS. 10 through 12 shows a ratchet wrench 10c in accordance with a fourth embodiment of the present invention, and same numbers are used to correlate similar components of the third embodiment, but bearing a letter c. The fourth embodiment differentiates from the third embodiment in that a body 20c further includes a head 21c delimiting a stop edge 25c in a receiving space 23c. Further, a gear wheel 30c differentiates from the gear wheel 30b in that it includes a protruded end 36c protruding from an outer circumference of one of first and second stop rims 34c and 35c and disposed outside the groove 33c. In the embodiment, the protruded end 36c protrudes from the second rim 35c. The protruded end 36c is engaged in the stop edge 25c. Furthermore, the second rim 35c has a first side 351c and a second side 352c opposite the first side 351c. The second side 352 abuts against the stop edge 25c. The protruded end 36c has a first length L1 extending radially out from the outer circumference of the second stop rim 35c. The outer circumference of the second stop rim 35c is distanced from an outer periphery of the first engaging area 32c at a second length L2. The first length L1 is smaller than the second length L2. In addition, the protruded end 36c reinforces the structure of the gear wheel 30c.

In view of the forgoing, the pawl mechanisms 40, 40a, and 40b can restrain the gear wheels 30, 30b, and 30c in the receiving spaces 23 and 23c, so there is no need to use a C-ring and/or a cap for retraining the gear wheels 30, 30b, and 30c in the receiving spaces 23, 23c. Likewise, there is no need to make the gear wheels 30, 30b, and 30c include a groove for receiving the C-ring. Therefore, the ratchet wrenches 10, 10a, 10b, and 10c are quicker and easier to assemble and the cost of manufacturing and assembly are reduced. Furthermore, the pawl mechanisms 40, 40a, and 40b include the flanges 44 and 44a restrained in the groove 23, and the gear wheel 30 is restrained in the receiving space 23 by the flanges 44 and 44a of the pawl mechanisms 40 and 40a. In addition, the flange 44 reinforces the structure of the second pawl 42 in the first embodiment and the flange 44a reinforces the structure of the first pawl 41a in the second embodiment, respectively. Likewise, the protruded end 36c reinforces the structure of the gear wheel 30c.

While the specific embodiments have been illustrated and described, numerous modifications come to mind without significantly departing from the spirit of invention, and the scope of invention is only limited by the scope of the accompanying claims.

What is claimed is:

1. A ratchet wrench with easy assembly comprising:
a body including a head, with the head delimiting a receiving space and a recess, with the receiving space extending through the body, with the body including two opposite lateral walls and a support wall extending between the two lateral walls made of the same material of the body, with the recess delimited by the two lateral walls and the support wall, with the recess connecting with the receiving space, with the recess delimiting an opening adjacent to the receiving space; and
a gear wheel disposed in the receiving space and including two opposite distal ends uncovered;
an inner circumference defining a driving area for attaching an object to be driven by the ratchet wrench and an outer circumference defining a first engaging area;
a pawl mechanism restrained in the recess and including a surface defining a second engaging area facing and in ratcheting engagement with the first engaging area; and
a groove defined on the outer circumference of the gear wheel, wherein the pawl mechanism engages with the groove and restrains the gear wheel in the receiving space.

2. The ratchet wrench as claimed in claim 1, wherein the pawl mechanism includes a first pawl, a second pawl and a biasing member disposed between the first and second pawls, with the biasing member including a first end abutting against the first pawl and a second end abutting against the second pawl.

3. The ratchet wrench as claimed in claim 2, wherein one of the first and second pawls includes the second engaging area, wherein the first engaging area includes a plurality of first teeth disposed circumferentially on the outer circumference of the gear wheel, and wherein the second engaging area includes a plurality of second teeth facing and in ratcheting engagement with the plurality of first teeth.

4. The ratchet wrench as claimed in claim 3, wherein the other of the first and second pawls includes a side forming an even surface facing the first engaging area and being able to loosely abut against a top land of each of the plurality of first teeth.

5. The ratchet wrench as claimed in claim 4, wherein the second engaging area includes a flange protruding therefrom and restrained in the groove.

6. The ratchet wrench as claimed in claim 3, wherein the other of the first and second pawls includes a side forming an even surface facing the first engaging area and being able to loosely abut against a top land of each of the plurality of first teeth.

7. The ratchet wrench as claimed in claim 6, wherein the side includes a flange protruding therefrom and restrained in the groove.

8. The ratchet wrench as claimed in claim 2, wherein the outer circumference of the gear wheel includes first and second stop rims opposite each other and the groove delimited between the first and second stop rims.

9. The ratchet wrench as claimed in claim 8, wherein the head delimits a stop edge in the receiving space and the gear wheel includes a protruded end engaging in the stop edge, and wherein the protruded end protrudes from the second rim and disposed outside the groove.

10. The ratchet wrench as claimed in claim 9, wherein the protruded end has a first length extending radially out from an outer circumference of one of the first and second stop rims, wherein the outer circumference of the one of the first and second stop rims is distanced from an outer periphery of the first engaging area at a second length, and wherein the first length is smaller than the second length.

11. The ratchet wrench as claimed in claim 3, wherein the groove extends annularly on the outer circumference of the gear wheel and transverses to the plurality of first teeth.

12. The ratchet wrench as claimed in claim 1, wherein each of the support wall and the mounting sides of the first and second pawls has a curved periphery.
